(19) United States
(12) Patent Application Publication
(10) Pub. No.: US 2012/0144726 A1
(43) Pub. Date: Jun. 14, 2012

(54) FLEXIBLE CANTILEVER USED FOR FISHING LURES

(76) Inventor: Mark A. PARSLOW, Riverside, IL (US)

(21) Appl. No.: 12/967,041

(22) Filed: Dec. 13, 2010

(51) Int. Cl. A01K 83/02; A01K 85/00; A01K 85/02

(52) U.S. Cl. 43/37; 43/34

(57) ABSTRACT

A component used in a fishing lure is disclosed. The component includes a flexible cantilever having a first end and a second end, wherein the first end is either connected to or capable of connecting to a hook and the second end is either connected to or capable of connecting to the fishing lure such that when a force sufficient enough to deflect the flexible cantilever is directly or indirectly applied to the flexible cantilever, the hook displaces with respect to the fishing lure.

### FIELD OF THE INVENTION

The present invention relates generally to fishing lures. More particularly, the present invention relates to novel designs and assembly methods for fishing lures that incorporate a flexible cantilever.

### BACKGROUND OF THE INVENTION

A fishing lure refers to an object that is designed to resemble a prey of a fish and is used to catch fish. During fishing, typically a fishing enthusiast or a fisherman casts a fishing line, attached at the end of which is a fishing lure. At least one hook is in turn attached to the fishing lure. A fish, attracted to the lure, bites that lure and the attached hook, as a result, hooks the fish.

Usually such things as the movement, vibration, and color of the lure serve to catch a fish's attention. During fishing, a fishing lure is continually cast out and retrieved, making the lure swim or produce a popping action such that it resembles a prey. Furthermore, many possible hiding places for fish can be explored by casting the lure under logs and on flats. Continual exploration for fish in flats or in difficult to reach places often leads to snagging of the hook to foreign bodies. By way of example, a hook may snag on debris, heavy or rooted objects, such as trees, rocks, heavy debris, or the like, either causing the fishing line to break, or forcing the fisherman to break the line himself. Along with the hook, the lure, which tends to be relatively expensive, also undesirably snags. This not only can result in wasting a considerable amount of time and effort in retrieving the lure, but it can also be expensive because often times the lure is irretrievable.

Certain lure designs attempt to provide a “snag-free” fishing experience by hiding or reducing exposure to the tip of a fish hook. By way of example, U.S. Pat. No. 4,562,661, issued to Messinger et al. and entitled “Fish Lure With Concealed Hooks” (hereinafter “the '661 patent”) discloses using a spring element that compresses a hook disposed inside a cavity of a lure. According to this mechanism, when a fish bites the lure, the biting action depresses a lever attached to the spring element. As a result, the hook is released and ejected to a position where it hooks the fish.

As another example, U.S. Pat. No. 6,651,375, issued to Parrish and entitled “Hard Body Weedless Fishing Lure” (hereinafter “the '375 patent”) discloses using a pin connection to attach a hook to a lure. Similar to the '661 patent, the hook in the '375 patent in its normal position is concealed inside a cavity of a lure. When the fish bites the lure, a moment at the pin connection causes the hook to rotationally displace and hook the fish.

As yet another example, U.S. Pat. No. 7,254,916, issued to Mussot and entitled “Lure” (hereinafter “the '916 Patent”) discloses using a clamping mechanism that is attached to a fishing line at one end and attached to a hook near the other end. Furthermore, a portion of the body of the clamping mechanism is attached to the top part of the cavity within the lure. In this design, when a fish bites the lure and the fishing line is pulled, the clamping mechanism depresses at one end, releasing the hook at the other end. The release causes the hook to move out from the cavity inside the lure, hooking the fish.

Unfortunately, the design described in each of these patents suffers from drawbacks. By way of example, each design is complex, greatly increasing the probability of component failure. In other words, the '661, the '375 and the '916 patents rely on, among other things, the success of a spring mechanism, a pin connection and a clamping mechanism, respectively, to hook a fish. If one of these complicated features were to fail or not operate as intended (e.g., due to rusting resulting from constant exposure to water), then the entire lure would be rendered useless.

As another example, such complex designs translate into increased manufacturing costs for the unique features, i.e., spring mechanism, pin connection and clamping mechanism. As yet another example, methods for assembling the complex fishing lure designs are time consuming. Therefore, the resulting manufacturing process is both expensive and suffers from low throughput.

What are therefore needed are designs and assembly methods for fishing lures that allow for easy production and use.

### SUMMARY OF THE INVENTION

In view of the foregoing, this invention provides a component used in a fishing lure. The component includes a flexible cantilever having a first end and a second end, wherein the first end is either connected to or capable of connecting to a hook and the second end is either connected to or capable of connecting to the fishing lure such that when a force sufficient enough to deflect the flexible cantilever is directly or indirectly applied to the flexible cantilever, the hook displaces with respect to said fishing lure.

In preferred embodiments of the present invention, the cantilever is made from one member selected from a group consisting of plastic, rubber, carbon fiber composite, and metal. The first end may be removably or permanently attached to a hook and the second end may be removably or permanently attached to the fishing lure. In preferred embodiments of the present invention, the first end may include a structure that allows the flexible cantilever to removably connect to the hook by any one of press fit, snap fit, latch fit, barb fit or other means familiar to those skilled in the art. Similarly, the second end may include a structure that allows the flexible cantilever to connect to the fishing lure by any one of press fit, snap fit, latch fit, barb fit or other means familiar to those skilled in the art.

The above-described inventive components may further include a shaft portion which has disposed at one end the above-mentioned first end and has disposed at another end the above-mentioned second end, and the second end is less flexible than a material which makes up the shaft portion. Less flexibility in the second end is effected by any one of—geometry of the second end, type of connection between the second end and the lure, or material from which the second end is composed.

In another aspect, the present invention provides a fishing lure. The fishing lure includes: (i) a lure portion; (ii) a substantially flexible cantilever portion; (iii) a hook portion; and wherein the substantially flexible cantilever portion has a first end and a second end, the first end is either permanently or removably communicatively coupled to the hook portion and the second end is either permanently or removably communicatively coupled to the fishing lure such that when a force sufficient enough to deflect the substantially flexible cantilever portion is directly or indirectly applied to the substantially flexible cantilever portion, the hook displaces with respect to said fishing lure.

In a preferred embodiment of the present invention, the substantially flexible cantilever portion is made from one member selected from a group consisting of plastic, rubber, carbon fiber composite, and metal. The first end may be either removably or permanently attached to the hook and the second end may be removably or permanently attached to the fishing lure. The first end may include a structure that allows the flexible cantilever to connect to the hook by any one of press fit, snap fit, latch fit, barb fit or other means familiar to those skilled in the art. Similarly, the second end may include a structure that allows the flexible cantilever to connect to the fishing lure by any one of press fit, snap fit, latch fit, barb fit or other means familiar to those skilled in the art.

The inventive cantilevers may further include a shaft portion which has disposed at one end the above-mentioned first end and has disposed at another end the above-mentioned second end, and the second end is made from a material that is less flexible than a material which makes up the shaft portion.

In preferred embodiments of the present invention, the lure includes a cavity portion configured to house the hook. The cavity portion preferably houses said substantially flexible cantilever portion. The cavity portion may include side walls that are sufficiently large such that when the substantially flexible cantilever portion is not deflected the hook portion does not extend beyond the side walls. Furthermore, the cavity portion may include side walls such that when the substantially flexible cantilever portion is deflected, the hook portion extends beyond the side walls.

In yet another aspect, the present invention provides a method of making a fishing lure. The method includes the steps of (i) obtaining a substantially flexible cantilever having a first end and a second end; (ii) attaching a hook to the first end; and (iii) communicatively coupling a lure to the second end, wherein when a force sufficient enough to deflect the substantially flexible cantilever is directly or indirectly applied to the substantially flexible cantilever, the hook displaces with respect to the lure.

In the above-mentioned step of obtaining, the substantially flexible cantilever may be capable of being removably or permanently attached to a hook at one end and at the other end may be capable of being removably or permanently attached to the lure. The inventive methods may further include positioning the hook inside a cavity defined inside the lure. In preferred embodiments of the present invention, when the force sufficient enough to deflect the substantially flexible cantilever is directly or indirectly applied to the substantially flexible cantilever, the hook protrudes out of the cavity defined inside the lure.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1A shows a side-sectional view of a sub-assembly including a removably attached flexible cantilever, according to one embodiment of the present invention, attached to a lure in a non-deflected state.

FIG. 1B shows a side-sectional view of the sub-assembly including the flexible cantilever shown in FIG. 1A and that is detached from the lure.

FIG. 2A shows a side-sectional view of an assembly including a permanently attached flexible cantilever, according to one embodiment of the present invention, in a non-deflected state and attached at one end to a lure and attached at the other end to a hook portion.

FIG. 2B shows a side-sectional view of the assembly including a flexible cantilever shown in FIG. 2A in a deflected state.

FIG. 3A shows a side-sectional view of an exemplar inventive fishing lure having a flexible cantilever, according to one preferred embodiment of the present invention, in a non-deflected state, recessed inside a cavity of a lure and attached at one end to the lure and attached at another end to a hook portion.

FIG. 3B shows a side-sectional view of the exemplar inventive fishing lure including the flexible cantilever shown in FIG. 3A in a deflected state such that the hook portion attached thereto protrudes out of the lure's cavity.

### DETAILED DESCRIPTION OF THE PREFERRED EMBODIMENTS

In the following description numerous specific details are set forth in order to provide a thorough understanding of the present invention. It will be apparent, however, to one skilled in the art that the present invention may be practiced without limitation to some or all of these specific details. In other instances, well known process steps have not been described in detail in order to not unnecessarily obscure the invention.

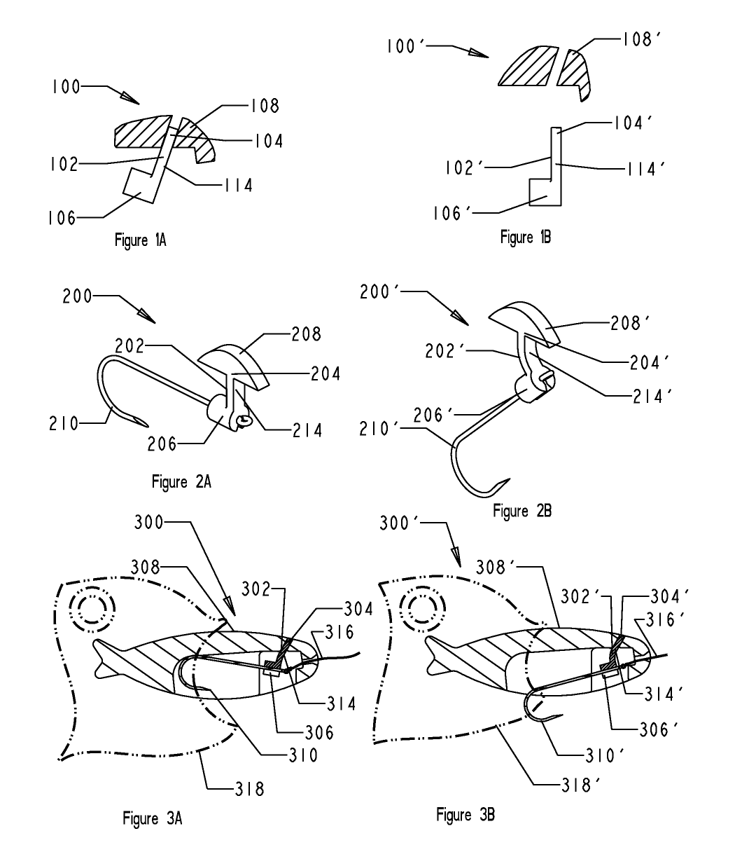

FIG. 1A shows a side-sectional view of a sub-assembly 100, according to one embodiment of the present invention, used in a fishing lure, which may be a snag-free design. Sub-assembly 100 includes a flexible cantilever 102 attached to a fishing lure 108. Flexible cantilever 102 has a first end 106 and a second end 104, both of which are disposed at either ends of a shaft portion 114. As shown in FIG. 1A, second end 104 is attached to fishing lure 108 and first end 106 has a shape that includes a structure that allows the flexible cantilever to connect to the hook by snap fit.

Shaft portion 114 is generally made from a substantially flexible material so that it is capable of deflecting under an external force produced by a biting action of a fish. It is preferably made from one member selected from a group consisting of plastic, rubber, carbon fiber composite, and metal In accordance with one embodiment of the present invention, first end 106 and second end 104 are made from the same flexible material as shaft portion 114. Lure 108 may be any fishing lure designed to attract game fish. In preferred embodiments of the present invention, lure 108 mimics the movement, shape and/or color of the prey of a game fish.

FIG. 1B shows a side-sectional view of sub-assembly 100′. Sub-assembly 100′ is substantially similar to sub-assembly 100 of FIG. 1A (i.e., flexible cantilever 102′, first end 106′, second end 104′, shaft portion 114′ and fishing lure 108′ of FIG. 1B are substantially same as their counterparts—flexible cantilever 102, first end 106, second end 104, shaft portion 114 and fishing lure 108 of FIG. 1A), except that flexible cantilever 102′ appears detached from fishing lure 108′, as opposed to flexible cantilever 102 attached to fishing lure 108 as shown in FIG. 1A.

As shown in FIG. 1B, flexible cantilever 102′ may be removably attached to fishing lure 108′. In other words, second end 104′ of flexible cantilever 102′ attached (see FIG. 1A) to fishing lure 108′ can be removed and reattached and then removed again. This removable feature of flexible cantilever 102′ allows other types of lures to be used during fishing. In this embodiment, second end 104′ is preferably made less flexible than the material of which shaft portion 114′ is composed. Less flexible design of the second end is effected by any one of—the geometry of the second end, type of connection between the second end and the lure, and the material from which the lure is composed. The present invention recognizes that it is not as important for second end 104′ to deflect as it is for shaft portion 114′. Second end 104 when made less flexible by means of geometry, fit, or material, which is not flexible like shaft portion 114, establishes a strong connection between flexible cantilever 102′ and lure 108′ that can withstand an external force (e.g., biting action of a fish or action of turbulently flowing water) acting upon lure 108.

In those embodiments of the present invention where a flexible cantilever is removably attached to a lure, second end 104′ of FIG. 1B is communicatively coupled to lure 108′ by any one of such methods as press fit, snap fit, latch fit, barb fit or other means familiar to those skilled in the art. Furthermore, second end 104 may be of an appropriate shape that allows for such communicative coupling between flexible cantilever 102′ and lure 108′ to be sturdy.

To manufacture embodiments shown in FIG. 1A, second end 104 and lure 108 may be molded separately or together, as one discrete unit. However, it is preferably to mold second end 104′ and lure 108′ of FIG. 1B as separate units so that they can removably engage with each other during the assembly process.

FIG. 2A shows a fishing lure 200, according to one embodiment of the present invention, which includes flexible cantilever 202 in a non-deflected state attached at a first end 206 to a hook portion 210. In FIG. 2A, other components 202, 204, 206, 208, and 214 are found in substantially the same configuration as their counterparts shown in FIG. 1A, i.e., 102, 104, 106, 108, and 114, respectively.

FIG. 2B shows a fishing lure 200′, which includes a flexible cantilever 202′ in a deflected state. In FIG. 2B, components 202′, 204′, 206′, 208′, 210′, and 214′ are found in substantially the same configuration as their counterparts of FIG. 2A, i.e., 202, 204, 206, 208, 210, and 214, respectively, except flexible cantilever 202′ is a deflected state, as opposed to flexible cantilever 202 which is a non-deflected state. As mentioned before, such a state is achieved when a fish bites a lure, applying a moment at the tip of flexible cantilever 202′ and causing flexible cantilever 202′ to deflect. This motion of deflection, in turn, mobilizes the hook to displace from its original position and go into a deflective motion which hooks a game fish.

FIG. 3A shows a snag-free fishing lure 300 in accordance with one embodiment of the present invention. In this embodiment, a fishing line 316 is connected to a first end 306 of flexible cantilever 302 and a hook portion 310 is recessed inside a cavity 312 of fishing lure 308. Preferably, the tip of hook portion 310 is not exposed when no or minimal force is applied by means of a fishing line attached to a hook. In this configuration, snagging the hook on objects such as rocks, trees or fish 318 is avoided because the hook is not exposed to such objects.

In FIG. 3A, components 302, 304, 306, 308, 310, and 314 are found in substantially the same configuration as their counterparts of FIG. 2A, i.e., 202, 204, 206, 208, 210 and 214.

FIG. 3B shows a snag-free fishing lure 300′, which is substantially similar to fishing lure 300 (of FIG. 3A), except that in FIG. 3B cantilever 302′ is in a deflected state. Components 302′, 304′, 306′, 308′, 310′, 312′, 314′ and 316′ of FIG. 3B are found in substantially the same configuration as their counterparts of FIG. 3A, i.e., 302, 304, 306, 308, 310, 312, 314, and 316, respectively.

When a large enough force is applied to fishing lure 300′, flexible cantilever 302′ deflects or flexes. As mentioned with respect to FIG. 2B, a hook goes into motion and displaces from its original position. In reference to FIG. 3B, when a game fish 318′ bites into lure 308′, the biting action flexes or deflects flexible cantilever 302′ (particularly shaft portion 314′), hook 310′ (attached to flexible cantilever 302′) in turn goes into motion, protruding out of cavity 312′, and hooking a game fish that is in the path of moving hook 310′.

In accordance with one embodiment of the present invention, a method of assembling fishing lure 300 as shown in FIG. 3A begins by obtaining a substantially flexible cantilever having a first end and a second end (e.g., substantially flexible cantilever 302 of FIG. 3A).

A lure (e.g., lure 308 of FIG. 3A) is then attached to a first end (e.g., first end 304 of substantially flexible cantilever 302 as shown in FIG. 3A). In one embodiment of the present invention, the lure may be fused or molded together as one component with the second end of the substantially flexible cantilever such that they create a single unit. In other embodiments of the present invention, the lure is removably attached to the lure, as shown in FIG. 1B.

Next, a hook (e.g., hook 310 of FIG. 3A) is connected to a first end (e.g., first end 306 of FIG. 3A) of the substantially flexible cantilever. It is not necessary to attach the lure to the flexible cantilever portion first and then attach the hook to the flexible cantilever portion. Rather, those skilled in the art will recognize that the hook may be attached to the flexible cantilever portion before attaching the lure to the flexible cantilever portion.

In those embodiments of the present invention where the lure, hook and the substantially flexible cantilever are fused or molded together (e.g., by injection molding) as one component such that they create a single unit, no assembly is required. In other embodiments of the present invention, the lure and the substantially flexible cantilever portion is molded around the hook portion. As a result, in this embodiment, assembly comprises attaching the hook portion to the first end of the substantially flexible cantilever portion. Furthermore, an additional step of attaching the second end of the substantially flexible cantilever portion to the lure need not be performed, as the substantially flexible cantilever portion and the lure comprise a single unit produced by a molding process. In yet other embodiments of the present invention, the lure is produced by a molding process, preferably injection molding and the substantially flexible cantilever portion and the hook portion are discrete components that are attached to form a snag-free lure design. In this embodiment, assembly requires embedding a significant or certain amount of the substantially flexible cantilever portion inside the lure produced from a molding process. This ensures a strong connection between the lure and the substantially flexible cantilever portion.

Fishing lures, according to the present invention, provide several advantages over the current designs. By way of example, the present invention represents a relatively simple design involving a deflecting member, such as a flexible cantilever that is attached to a fishing lure. When a game fish bites on the lure, the flexible cantilever deflects. As will be explained below in connection with FIGS. 2A-2B and 3A-3B, the act of deflection puts a hook into motion such that it hooks the fish. Fishing lures of the present invention do not have extra components, such as a spring mechanism, pin connection or clamping mechanism to effect the hooking of game fish. Rather, fishing lures of the present invention require integrating essential components to achieve the result intended by the current fishing lure designs. As a result, the concern of component failure associated with current fishing lures is either significantly reduced or entirely eliminated.

As another example, the present inventions' simpler design also translates into reduced production costs and reduced assembly time or higher throughput for the fishing lure.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A component used in a fishing lure, said component comprising a flexible cantilever having a first end and a second end, wherein said first end is either connected to or capable of connecting to a hook and said second end is either connected to or capable of connecting to said fishing lure such that when a force sufficient enough to deflect said flexible cantilever is directly or indirectly applied to said flexible cantilever, said hook displaces with respect to said fishing lure.

2. The component of claim 1, wherein said flexible cantilever is made from one member selected from a group consisting primarily of plastic, rubber, carbon fiber composite, and metal.

3. The component of claim 1, wherein said first end is permanently or removably attached to said hook.

4. The component of claim 1, wherein said second end is permanently or removably attached to said fishing lure.

5. The component of claim 4, wherein said second end includes a structure that allows said flexible cantilever to connect to said fishing lure by any one of press fit, snap fit, latch fit, and barb fit.

6. The component of claim 1, wherein said cantilever further comprises a shaft portion which has disposed at one end said first end and has disposed at another end said second end, and said second end is made less flexible than a material which makes up the shaft portion.

7. A fishing lure comprising:
a lure portion;
a substantially flexible cantilever portion;
a hook portion; and
wherein said substantially flexible cantilever portion has a first end and a second end, said first end is either permanently or removably connected to said hook portion and said second end is either permanently or removably communicatively coupled to said fishing lure such that when a force sufficient enough to deflect said substantially flexible cantilever portion is directly or indirectly applied to said substantially flexible cantilever portion, said hook displaces with respect to said fishing lure.

8. The component of claim 7, wherein said substantially flexible cantilever portion is made from one member selected from a group consisting of plastic, rubber, carbon fiber composite, and metal.

9. The component of claim 7, wherein said first end is permanently or removably attached to a said hook.

10. The component of claim 9, wherein said removably attached first end includes a structure that allows said flexible cantilever to connect to said hook by any one of press fit, snap fit, latch fit, and barb fit.

11. The component of claim 7, wherein said second end is permanently or removably attached to said fishing lure.

12. The component of claim 11, wherein said removably attached second end includes a structure that allows said flexible cantilever to connect to said fishing lure by any one of press fit, snap fit, latch fit, and barb fit.

13. The component of claim 7, wherein said cantilever further comprises a shaft portion which has disposed at one end said first end and has disposed at another end said second end, and said second end is made less flexible than a material which makes up the shaft portion.

14. The component of claim 7, wherein said lure includes a cavity portion configured to house said hook.

15. The component of claim 14, wherein said cavity portion houses said substantially flexible cantilever portion.

16. The component of claim 15, wherein said cavity portion includes side walls that are sufficiently large such that when said substantially flexible cantilever portion is not deflected that said hook portion does not extend beyond said side walls.

17. The component of claim 15, wherein said cavity portion includes side walls such that when said substantially flexible cantilever portion is deflected, said hook portion extends beyond said side walls.

18. A method of making a snag-free fishing lure:
obtaining substantially flexible cantilever having a first end and a second end;
attaching a hook to said first end;
communicatively coupling a lure to said second end;
wherein when a force sufficient enough to deflect said substantially flexible cantilever is directly or indirectly applied to said substantially flexible cantilever, said hook displaces with respect to said lure.

19. The method of claim 18, wherein in said obtaining, said substantially flexible cantilever is capable of permanently or removably attaching to a hook at one end and at the other end is capable of permanently or removably attaching to a lure.

20. The method of claim 18, further comprising positioning said hook inside a cavity defined inside said lure.

21. The method of claim 20, wherein when said force sufficient enough to deflect said substantially flexible cantilever is directly or indirectly applied to said substantially flexible cantilever, said hook protrudes out of said cavity defined inside said lure.
